(19) United States
(12) Patent Application Publication
(10) Pub. No.: US 2015/0122512 A1
(43) Pub. Date: May 7, 2015

(54) FOAM-TYPE FIRE DISTINGUISHING DEVICE

(71) Applicant: Shang-Hua Wu, Taichung (TW)

(72) Inventor: Shang-Hua Wu, Taichung (TW)

(21) Appl. No.: 14/521,484

(22) Filed: Oct. 23, 2014

(30) Foreign Application Priority Data
Nov. 4, 2013 (TW) 102220531

(51) Int. Cl. A62C 5/02

(52) U.S. Cl. CPC A62C 5/022
USPC 169/9

(57) ABSTRACT

A The foam-type fire distinguishing device includes a water supply unit, a container, a mixing tank, an increasing pressure tank, a pressure device, a transmitting unit and a spray device. The transmitting unit delivers water from the water supply unit and the foam agent from the container to be mixed in the mixing tank to create the water-foam mixture which is then sent to the increasing pressure tank which introduces pressurized air to the water-foam mixture to create fine foams. The water-foam mixture with fine foams are sprayed from the spray device to increase the spread area to increase the efficiency of distinguishing fire.

### BACKGROUND OF THE INVENTION

1. Fields of the Invention

The present invention relates to a fire distinguishing device, and more particularly, to a foam-type fire distinguishing device providing more foam to cover a larger area.

2. Descriptions of Related Art

The conventional foam-type fire distinguishing device generally mixes water and foam agent to generate foam-water mixture which is pressurized to be sprayed out from the spray device. The conventional foam-type fire distinguishing device comprises a pump, two mixing tanks, a pressure tank, a foam agent container and spray device. The pump sends water to the first mixing tank so as to be mixed with the foam agent delivered from the foam agent at the ratio about 1:100. When the water-foam mixture passes through the mixing tank, pressurized air is introduced into the second mixing tank from the pressure tank to create the desired water-foam mixture which is sprayed from the spray device to distinguish fire. It is known that the higher density of the foam, the less oxygen is provided to the fire, nevertheless, the pressurized air of the conventional foam-type fire distinguishing device is directly introduced into the second mixing tank which has limited space so that the water-foam mixture cannot contain sufficient foams and the foams are too large to efficiently separate the oxygen from the fire.

The present invention intends to provide a foam-type fire distinguishing device to eliminate the shortcomings mentioned above.

### SUMMARY OF THE INVENTION

The present invention relates to a foam-type fire distinguishing device and comprises a water supply unit, a container, a mixing tank, an increasing pressure tank, a pressure device, a transmitting unit and a spray device. The transmitting unit delivers water from the water supply unit and the foam agent from the container to be mixed in the mixing tank to create the water-foam mixture which is then sent to the increasing pressure tank which introduces pressurized air to the water-foam mixture to create fine foams. The water-foam mixture with fine foams are sprayed from the spray device to increase the spread area to increase the efficiency of distinguishing fire.

The primary object of the present invention is to provide a foam-type fire distinguishing device that reduces the resistance in the pipes and increases the spray speed so as to cover a larger area and have more fine foams.

Another object of the present invention is to provide a foam-type fire distinguishing device that is able to be used in different types of buildings and the foam-type fire distinguishing device is cooperated with a movable base that is easily moved to desired areas to distinguish the fire.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 shows the arrangement of the parts of the foam-type fire distinguishing device of the present invention;

FIG. 2 shows another embodiment of the arrangement of the parts of the foam-type fire distinguishing device of the present invention;

FIG. 3 shows that the foam-type fire distinguishing device of the present invention is arranged on a base, and

FIG. 4 shows the control module of the foam-type fire distinguishing device of the present invention.

### DETAILED DESCRIPTION OF THE PREFERRED EMBODIMENT

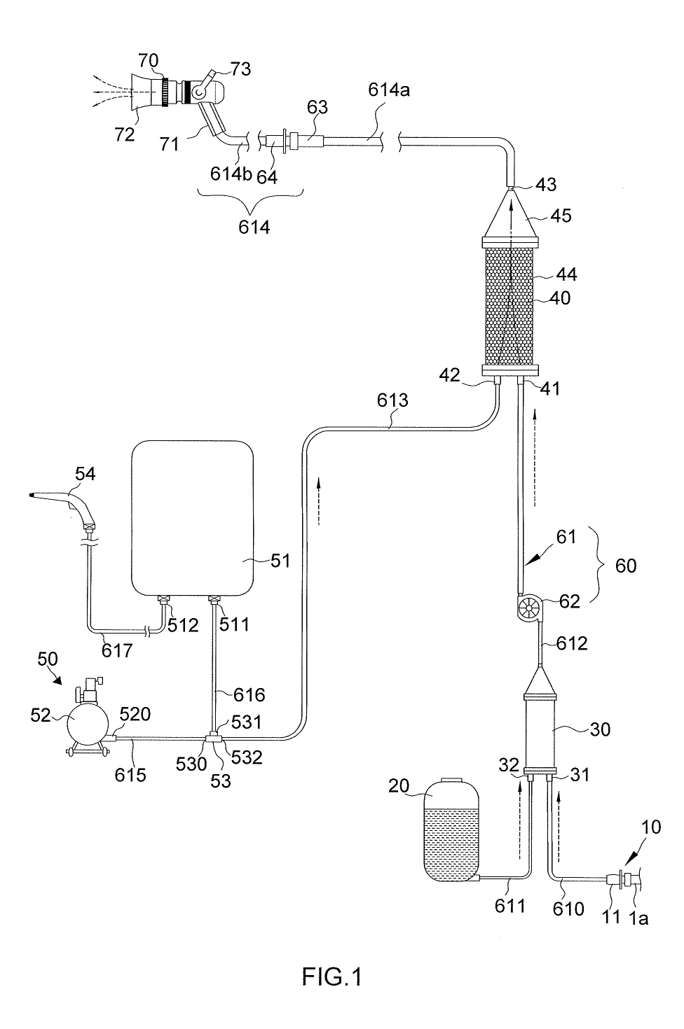

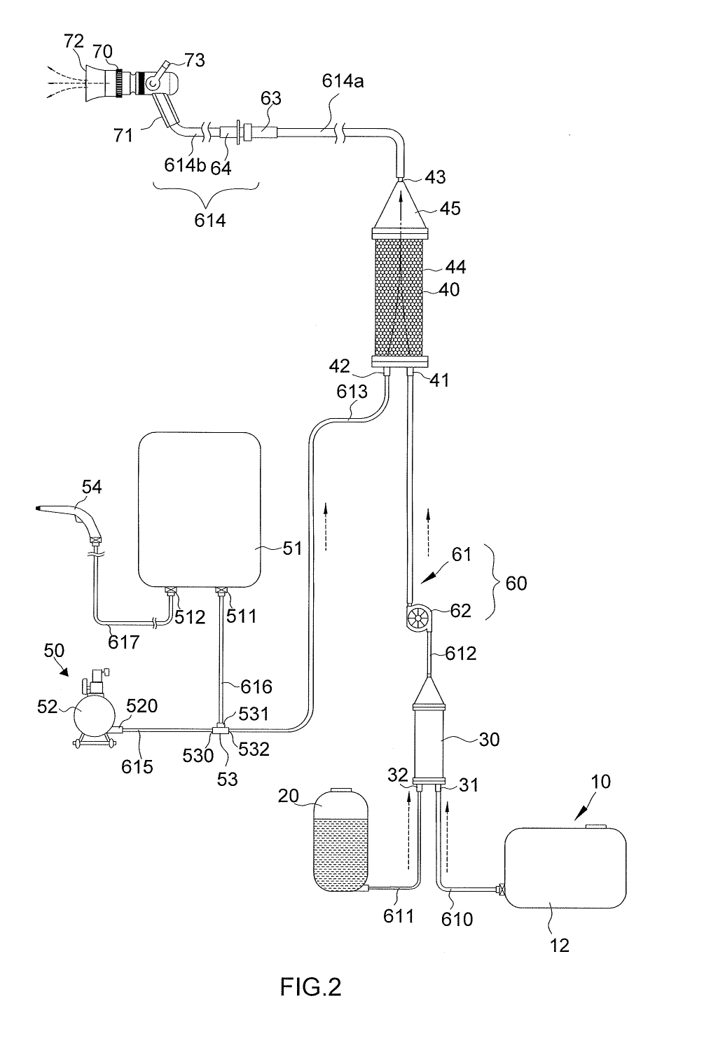

Referring to FIGS. 1 and 2, the foam-type fire distinguishing device of the present invention comprises a water supply unit 10, a first container 20, a mixing tank 30, an increasing pressure tank 40, a pressure device 50, a transmitting unit 60 and a spray device 70. The water supply unit 10 provides water to the foam-type fire distinguishing device and the first container 20 receives foam agent therein. The mixing tank 30 has a first inlet 31 connected with the water supply unit 10, a second inlet 32 connected with the first container 20, and a first exit 33. The increasing pressure tank 40 has a third inlet 41 connected with the first exit 33, a fourth inlet 42, and a second exit 43. The pressure device 50 is connected with the fourth inlet 42.

The transmitting unit 60 delivers the water from the water supply unit 10 and the foam agent from the first container 20 at a desired ratio to the mixing tank 30 to create water-foam mixture. The water-foam mixture is then sent to the increasing pressure tank 40. The pressure device 50 introduces pressurized air into the increasing pressure tank 40 to create fine foams to the water-foam mixture and increase the density of the fine foams in the water-foam mixture. The spray device 70 has an input end 71 and an output end 72, the input end 71 is connected with the second exit 43 of the increasing pressure tank 40. The spray device 70 has a trigger 73 to control the spray action of the spray device 70.

As shown in FIG. 1, the water supply unit 10 is a quick connector 11 which can be a male connector of different sizes, and the quick connector 11 is able to be connected with a receptacle member 1 a such as a female receptacle member by an adaptor. In other words, the quick connector 11 of the foam-type fire distinguishing device of the present invention can be quickly connected to the receptacle member la installed at hydrants of the building. As shown in FIG. 2, the water supply unit 10 is a second container 12 for receiving water therein so as to be set at fixed positions of a building or is connected with a mobile carrier.

As shown in FIGS. 1 and 2, the transmitting unit 60 comprises a pipe unit 61 and a pump 62. The pipe unit 61 has a first pipe 610 connected with the water supply unit 10 and the first inlet 31, a second pipe 611 connected with the first container 20 and the second inlet 32, a third pipe 612 connected with the first exit 33 and the third inlet 41, a fourth pipe 613 connected with the fourth inlet 42 and the pressure device 50, and a fifth pipe 614 connected with the second exit 43 and the input end 71. The pump 62 connected to the third pipe 612. The increasing pressure tank 40 comprises a cylindrical body 44 and a cone-shaped cover 45. The increasing pressure tank 40 has an open first end and a closed second end, the cone-shaped cover 45 seals the open first end, and the third inlet 41 and the fourth inlet 42 are connected to the closed second end. The second exit 43 is located at the tip of the cone-shaped cover 45. By changing the direction that the water-foam mixture, the resistance of the water-foam mixture in the pipes is reduced so that the speed ejected from the second exit 43 is increased.

The pressure device 50 comprises a higher pressure storage bottle 51 and a compressor 52 having a first air exit 520. The higher pressure storage bottle 51 has an air-inlet 511 and a second air exit 512. A sixth pipe 615 is connected between the first air exit 520 and an entrance 530 of a tri-tube 53. The tri-tube 53 has a first outlet 531 and a second outlet 532. A seventh pipe 616 is connected between the air-inlet 511 and the first outlet 531. The fourth pipe 613 is connected between the second outlet 532 and the fourth inlet 42. An eighth pipe 617 is connected between the second air exit 512 and an air nozzle 54. The fifth pipe 614 comprises a ninth pipe 614a and a hose 614b. The ninth pipe 614a is connected between the second exit 43 and the receptacle member 63. The hose 614b is connected between the output end 72 and the second connector 64 which is connected to the receptacle member 63. The ratio of the water-foam mixture comprises 0.3-0.5 by weight of foams and 100 by weight of water.

As shown in FIGS. 1 to 4, the second embodiment of the foam-type fire distinguishing device comprises a power supply unit 10, a first container 20, a mixing tank 30, an increasing pressure tank 40, a pressure device 50, a transmitting unit 60, a spray device 70 and a base 80. The water supply unit 10 provides water to the foam-type fire distinguishing device and the first container 20 receives foam agent therein. The mixing tank 30 has a first inlet 31 connected with the water supply unit 10, a second inlet 32 connected with the first container 20, and a first exit 33. The increasing pressure tank 40 has a third inlet 41 connected with the first exit 33, a fourth inlet 42, and a second exit 43. The pressure device 50 has an third outlet 532a which is connected with the fourth inlet 42.

The transmitting unit 60 delivers the water from the water supply unit 10 and the foam agent from the first container 20 at a desired ratio to the mixing tank 30 to create water-foam mixture. The water-foam mixture is then sent to the increasing pressure tank 40. The pressure device 50 introduces pressurized air into the increasing pressure tank 40 to create fine foams to the water-foam mixture and increase the density of the fine foams in the water-foam mixture. The spray device 70 has an input end 71 and an output end 72, the input end 71 is connected with the second exit 43 of the increasing pressure tank 40. The spray device 70 has a trigger 73 to control the spray action of the spray device 70. The base 80 has the water supply unit 10, the first container 20, the mixing tank 30, the pressure device 50, the transmitting unit 60 and the spray device 70 connected thereto. The base 80 has multiple wheels 81 connected thereto so that the foam-type fire distinguishing device is movable to desired positions of a building. The base 80 can also be connected to carts, motorbikes or other vehicles.

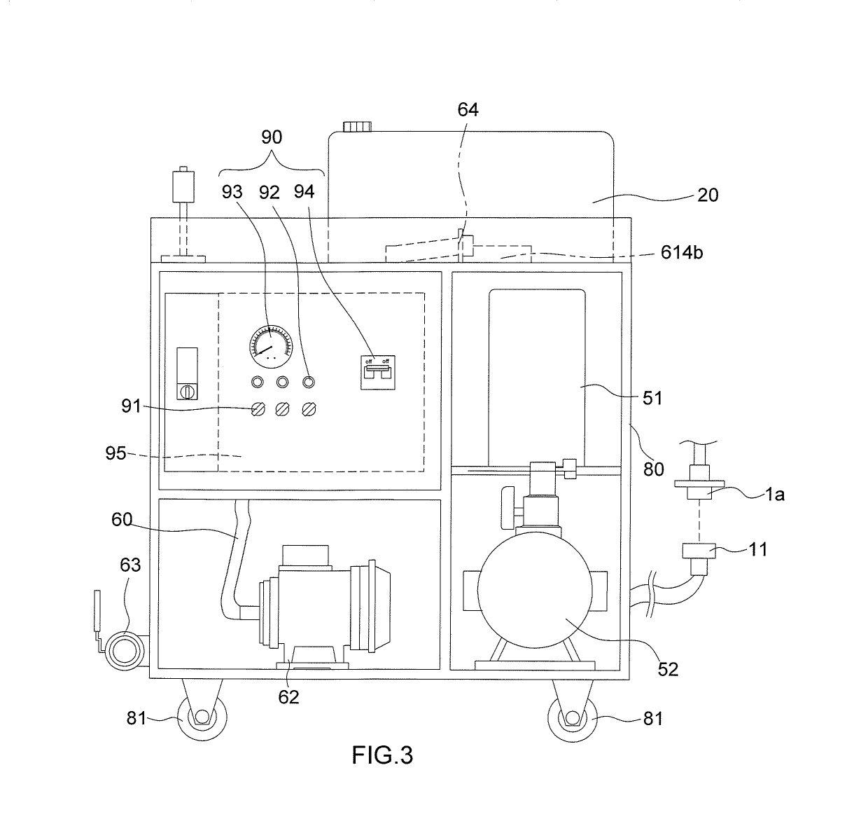

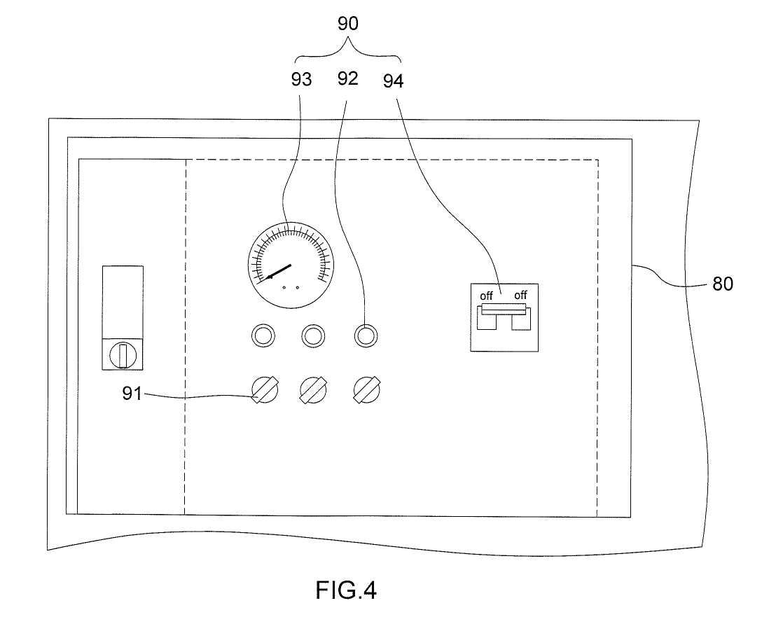

As shown in FIGS. 3 and 4, the foam-type fire distinguishing device also comprises a control module 90 and a power supply unit 95 such as a battery unit. The control module 90 controls the pressure device 50 and the transmitting unit 60, and the power supply unit 95 provides power to the transmitting unit 60, the spray device 70 and the pressure device 50. The control module 90 comprises multiple buttons 91, indication lights 92, an air pressure meter 93 and a power switch 94. When the user operates the buttons 91, the compressor 52 and the pump 62 are respectively activated, the compressor 52 introduces pressurized air into the higher pressure storage bottle 51, the pump 62 delivers water from the water supply unit 10 so as to be mixed with the foam agent from the first container 20 in the mixing tank 30 in which the water-foam mixture is created. The water-foam mixture is sent to the increasing pressure tank 40 which provides pressure to the water-foam mixture to create more fine foams. Because the direction that the water-foam mixture enters into the increasing pressure tank 40 is parallel with the direction that the pressurized air enters into the increasing pressure tank 40, so that the water-foam mixture and the pressurized air move smoothly. The second exit 43 of the increasing pressure tank 40 is located at the tip of the cone-shaped cover 45, so that stream of the water-foam mixture can move at higher speed. The larger space in the increasing pressure tank 40 allows more fine foams to be created. The user pulls the trigger 73 and the water-foam mixture is ejected from the output end 72. The water-foam mixture comprises 0.3-0.5 by weight of foams and 100 by weight of water. A valve (not shown) can also be used to adjust the ratio of the water and the foams.

While we have shown and described the embodiment in accordance with the present invention, it should be clear to those skilled in the art that further embodiments may be made without departing from the scope of the present invention.

What is claimed is:

1. A foam-type fire distinguishing device comprising:
a power supply unit for providing water;
a first container for receiving foam agent therein;
a mixing tank having a first inlet connected with the water supply unit, a second inlet connected with the first container, and a first exit;
an increasing pressure tank having a third inlet connected with the first exit, a fourth inlet, and a second exit;
a pressure device;
a transmitting unit for delivering the water and the foam agent at a ratio to the mixing tank to create water-foam mixture, the water-foam mixture being sent to the increasing pressure tank, the pressure device introducing pressurized air into the increasing pressure tank to create fine foams of the water-foam mixture, and a spray device having an input end and an output end, the input end connected with the second exit of the increasing pressure tank, the spray device having a trigger.

2. The foam-type fire distinguishing device as claimed in claim 1, wherein the water supply unit has a receptacle member which is connected with a quick connector which is adapted to be connected with a water source.

3. The foam-type fire distinguishing device as claimed in claim 2, wherein the water supply unit is a second container for receiving water.

4. The foam-type fire distinguishing device as claimed in claim 1, wherein the transmitting unit comprises a pipe unit and a pump, the pipe unit has a first pipe connected with the water supply unit and the first inlet, a second pipe connected with the first container and the second inlet, a third pipe connected with the first exit and the third inlet, a fourth pipe connected with the fourth inlet and the pressure device, and a fifth pipe connected with the second exit and the input end, the pump connected to the third pipe.

5. The foam-type fire distinguishing device as claimed in claim 4, wherein the fifth pipe comprises a ninth pipe and a hose, the pipe is connected between the second exit and the receptacle member, the hose is connected between the output end and a second connector which is connected to the receptacle member.

6. The foam-type fire distinguishing device as claimed in claim 4, wherein the pressure device comprises a higher pressure storage bottle and a compressor having a first air exit, the higher pressure storage bottle has an air-inlet and a second air exit, a sixth pipe is connected between the first air exit and an entrance of a tri-tube, the tri-tube has a first outlet and a second outlet, a seventh pipe is connected between the air-inlet and the first outlet, the fourth pipe is connected between the second outlet and the fourth inlet, an eighth pipe is connected between the second air exit and an air nozzle.

7. The foam-type fire distinguishing device as claimed in claim 1, wherein the increasing pressure tank comprises a cylindrical body and a cone-shaped cover, the increasing pressure tank has an open first end and a closed second end, the cone-shaped cover seals the open first end, the third inlet and the fourth inlet are connected to the closed second end, the second exit is located at a tip of the cone-shaped cover.

8. The foam-type fire distinguishing device as claimed in claim 1, wherein the water-foam mixture comprises 0.3-0.5 by weight of foams and 100 by weight of water.

9. The foam-type fire distinguishing device as claimed in claim 1 further comprising a base to which the water supply unit, the first container, the mixing tank, the pressure device, the transmitting unit and the spray device are connected.

10. The foam-type fire distinguishing device as claimed in claim 9, wherein the base has multiple wheels connected thereto.
